(19) United States
(12) Patent Application Publication
(10) Pub. No.: US 2023/0409307 A1
(43) Pub. Date: Dec. 21, 2023

(54) AUTOMATIC PROGRESSIVE ROLLOUT OF SOFTWARE UPDATE

(71) Applicant: Harness Inc., San Francisco, CA (US)

(72) Inventors: Dave Johnston, Belfast (GB); Andrew Hayes, Belfast (GB); Christopher Blakely, Belfast (GB)

(73) Assignee: Harness Inc., San Francisco, CA (US)

(21) Appl. No.: 17/841,645

(22) Filed: Jun. 15, 2022

(51) Int. Cl. G06F 8/65; H04L 67/00

(52) U.S. Cl. CPC G06F 8/65; H04L 67/34

(57) ABSTRACT

The present system automatically allows a user to create a pipeline for performing a progressive rollout and automatically performs the rollout in progressive steps. As part of creating a pipeline, a user creates multiple rollout phases and multiple approval phases. At each rollout phase, a portion of users using the current version of a software receive a rollout or update. The types of users may be configured based on user attributes. The approval phase for each rollout may determine if the software at the customer location is satisfying certain key performance indicator (KPI) requirements and whether the software update is correcting what it was intended to address. The present technology may automatically apply the updates, automatically review the performance of the updated application, and automatically approve the rollout to move onto the next phase, all without any administrator decisions.

### BACKGROUND

Applying software updates to computing systems are a tedious task that require considerable manual work. Typically, software updates require manual rollouts to client machines which execute the software locally or within a cloud computing service. Typically, the updates do not go as planned and issues exist with the update. Analyzing the update issue is typically performed manually, which makes each update take many days to complete. In particular, an administrator must manually rollout the update, manually determine whether the update was successful, and manually determine, if the update is not working, how to correct the update. What is needed is an improved method for rolling out software to customer devices.

### SUMMARY

The present technology, roughly described, automatically allows a user to create a pipeline for performing a progressive rollout and automatically performs the rollout in progressive steps. As part of creating a pipeline, a user creates multiple rollout phases and multiple approval phases. At each rollout phase, a portion of users using the current version of a software receive a rollout or update. The portion of total users and types of users that receive the update is configurable, and may increase with subsequent rollout phases. The types of users may be configured based on user attributes. The approval phase for each rollout may determine if the software at the customer location is satisfying certain key performance indicator (KPI) requirements and whether the software update is correcting what it was intended to address. The present technology may automatically apply the updates, automatically review the performance of the updated application, and automatically approve the rollout to move onto the next phase, all without any administrator decisions.

In some instances, the present technology provides a method for automatically rolling out updates in phases. The method begins by configuring a plurality of rollout phases for an update to be applied to a plurality of remote machines, wherein each remote machine is associated with a user. The method continues with configuring a plurality of approval phases, each of the plurality of rollout phase associated with a rule set for determining if a software update is approved. A software update is provided to software associated with a first subset of the plurality of remote machines, the first subset associated with a first rollout and based on a first subset of the plurality of users associated with the subset of the plurality of machines. Then, the method automatically determining if the provided software update is approved based on the rule set, the rule set including one or more rules based on one or more key performance indicators for the software and one or more rules based on the performance of the software update. The software update is automatically provided to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

In some instances, a non-transitory computer readable storage medium includes embodied thereon a program, the program being executable by a processor to perform a method for automatically rolling out updates in phases. The method begins by configuring a plurality of rollout phases for an update to be applied to a plurality of remote machines, wherein each remote machine is associated with a user. The method continues with configuring a plurality of approval phases, each of the plurality of rollout phase associated with a rule set for determining if a software update is approved. A software update is provided to software associated with a first subset of the plurality of remote machines, the first subset associated with a first rollout and based on a first subset of the plurality of users associated with the subset of the plurality of machines. Then, the method automatically determining if the provided software update is approved based on the rule set, the rule set including one or more rules based on one or more key performance indicators for the software and one or more rules based on the performance of the software update. The software update is automatically provided to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

In some instances, a system for automatically rolling out updates in phases includes a server having a memory and a processor. One or more modules can be stored in the memory and executed by the processor to configure a plurality of rollout phases for an update to be applied to a plurality of remote machines, wherein each remote machine is associated with a user, configure a plurality of approval phases, each of the plurality of rollout phase associated with a rule set for determining if a software update is approved, provide a software update to software associated with a first subset of the plurality of remote machines, the first subset associated with a first rollout and based on a first subset of the plurality of users associated with the subset of the plurality of machines, automatically determine if the provided software update is approved based on the rule set, the rule set including one or more rules based on one or more key performance indicators for the software and one or more rules based on the performance of the software update, and automatically provide the software update to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

### BRIEF DESCRIPTION OF FIGURES

FIG. 1 is a block diagram for automatically performing a progressive rollout.

FIG. 2 is a block diagram of a rollout application.

FIG. 3 is a method for automatically configuring a progressive rollout.

FIG. 4 is a method for configuring rollout phase rules.

FIG. 5 is a method for configuring approval phase rules.

FIG. 6 is a method for performing a progressive rollout.

FIG. 7 is a method for associating users with rollout groups based on retrieved rules.

FIG. 8 is an interface for creating a rollout pipeline.

FIG. 9 is an interface for selecting rollout attributes.

FIG. 10 is a method for adding users to a group.

FIG. 11 is a block diagram of a computing environment for implementing the present technology.

### DETAILED DESCRIPTION

The present system automatically allows a user to create a pipeline for performing a progressive rollout and automatically performs the rollout in progressive steps. As part of creating a pipeline, a user creates multiple rollout phases and multiple approval phases. At each rollout phase, a portion of users using the current version of a software receive a rollout or update. The portion of total users and types of users that receive the update is configurable, and may increase with subsequent rollout phases. The types of users may be configured based on user attributes. The approval phase for each rollout may determine if the software at the customer location is satisfying certain key performance indicator (KPI) requirements and whether the software update is correcting what it was intended to address. The present technology may automatically apply the updates, automatically review the performance of the updated application, and automatically approve the rollout to move onto the next phase, all without any administrator decisions.

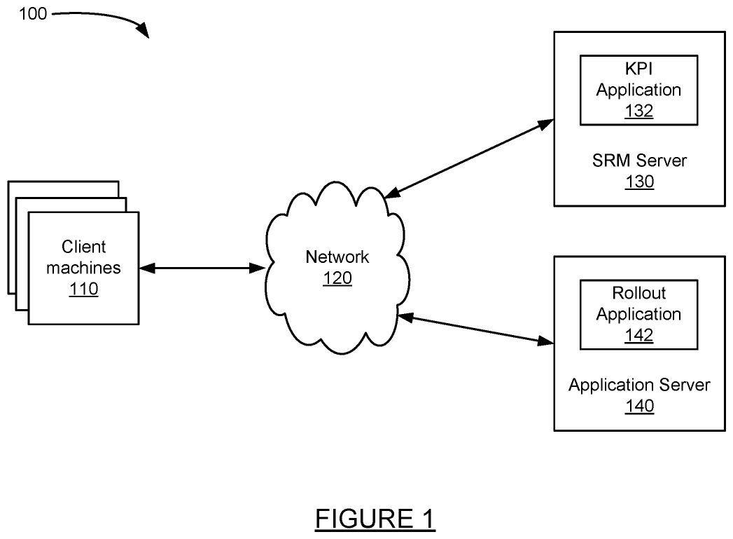

FIG. 1 is a block diagram for automatically performing a progressive rollout. The system of FIG. 1 includes client machines 110, network 120, service reliability manager (SRM) server 130, and application server 140.

The client machines 110, SRM server 130, and application server 140 communicate over network 120. Network 120 may include any private network, public network, the Internet, an intranet, a wide area network, a local area network, a cellular network, a Wi-Fi network, or any other network suitable of transmitting digital or analog data between two or more machines.

Client machines 110 may communicate with application server 140 to utilize software or a software service provided by application server 140. The client machines 110 may be standalone machines, or in some instances may be implemented within an environment provided by a cloud computing service provider. SRM server 130 may monitor software provided by application server 140, and determine the health and performance of the software. In particular, KPI application 132 may track and monitor software provided by application server 140 to determine key performance indicators and other health and performance data. KPI application 132 may monitor client machines 110 and application server 140 to determine the health of any software or service managed by application server 140. KPI application 132 may access data regarding the performance of software and hardware, calculate KPIs, and then may report the KPIs to requesting entities, such as rollout application 142.

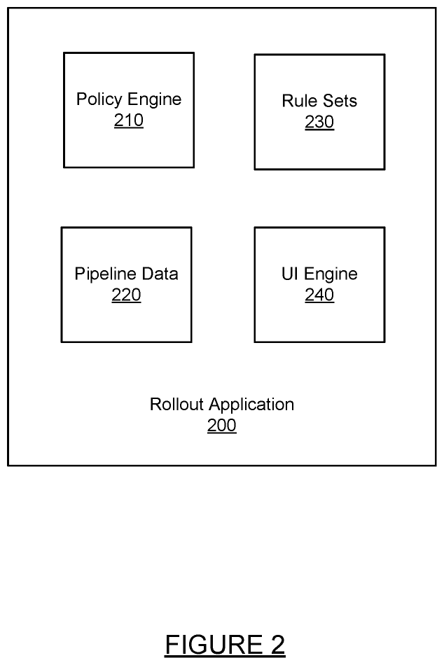

Application server 140 may provide software or a software service to client machines 110. Rollout application 142 implemented on application server 140 may rollout updates to client machines 110 that utilize the software or service provided by application server 140. Rollout application 142 may manage automatic progressive rollouts provided to client machines 110. Rollout application 142 may provide an interface for creating a rollout pipeline, allow users to generate pipeline rollout and approval phases, and distribute the rollout updates. Application 142 is discussed in more detail with respect to FIG. 2.

FIG. 2 is a block diagram of a rollout application. The application 200 of FIG. 2 provides more detail for rollout application 140 of the system of FIG. 1. Rollout application of FIG. 2 includes policy engine 210, pipeline data 220, rule sets 230, and UI engine 240. Policy engine 210 may execute rule sets based on pipeline data. For example, policy engine 210 may execute rule sets based on pipeline data to place users in a particular group, determine if KPI thresholds are satisfied, and other data. Policy engine 210 may also manage the automatic progressive rollouts of software updates.

Pipeline data 220 may include data entered by a user into a user interface while creating pipeline rollout phases and approval phases. Examples of pipeline data may include usernames, the size of rollout groups, the KPIs used to approve a rollout, and other data.

Rule sets 230 include the rules generated by a user while creating a progressive rollout pipeline. Examples of rule sets include rules used to place users inside groups and rules for determining whether KPIs satisfy thresholds.

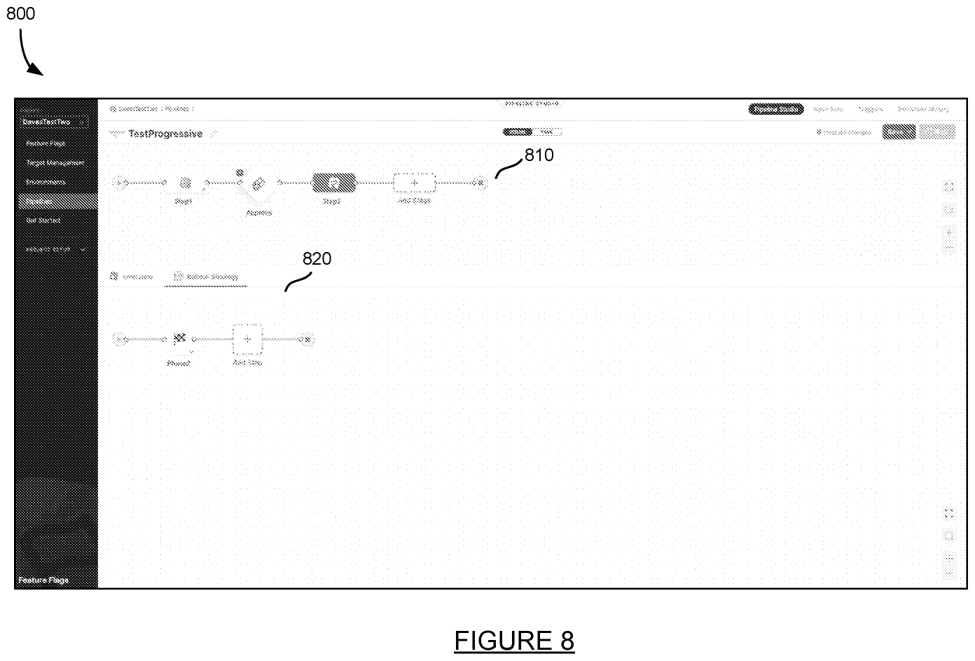

UI engine 240 manages a user interface provided to a user to create a pipeline and executes a progressive rollout. The UI 240 may be provided within a network page suitable to be rendered within a network browser, as a standalone application, or in some other format. Examples of a user interface managed by UI engine 240 are illustrated with respect to FIGS. 8-10.

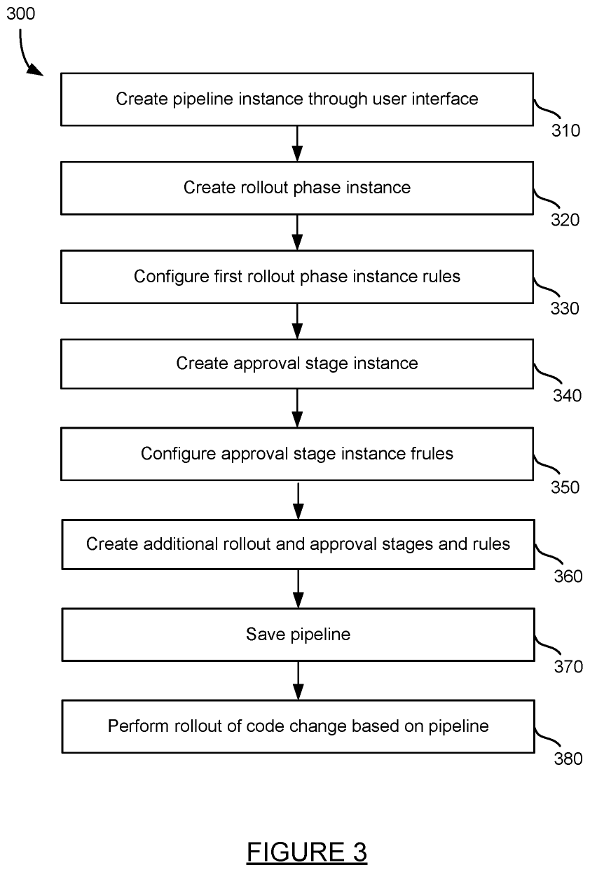

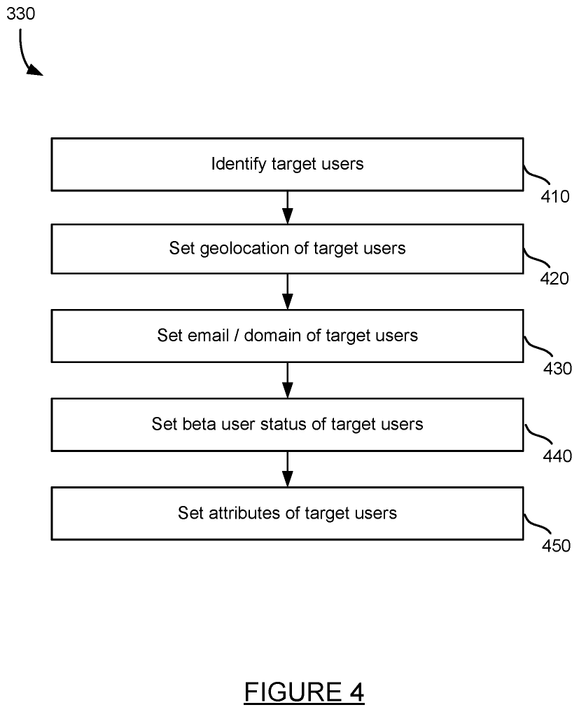

FIG. 3 is a method for automatically configuring a progressive rollout. A pipeline instance is created through user interface at step 310. The pipeline instance may include pipeline phases and the details for each pipeline phase. A first rollout phase instance is created at step 320. Each rollout phase instance can be executed to perform a rollout for a software update to a select number or percentage of users. The first rollout rules are created at step 330. Several rules may be configured for a first rollout state, including users to include in the target group, size of the target group, KPI data to analyze, and other rules. More detail for configuring first rollout stage rules is discussed with respect to the method of FIG. 4.

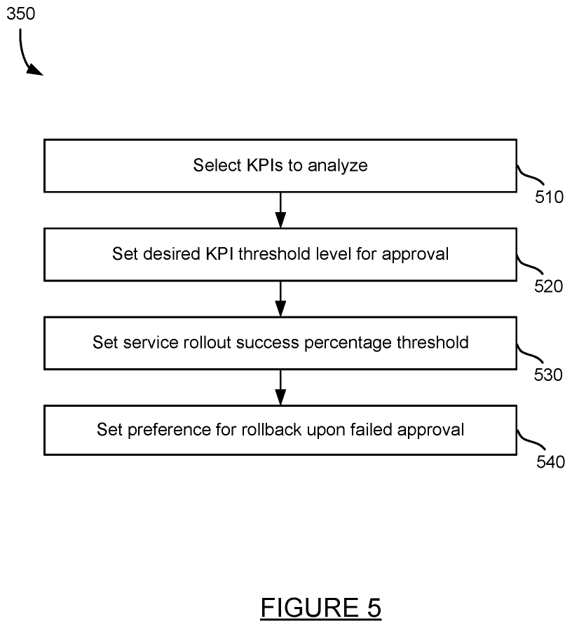

An approval phase instance is created at step 340. An approval phase instance handles the approval of the results of a software rollout. Approval phase instance rules are configured at step 350. The approval phase instance rules can include a threshold to compare KPI data and which KPI indicators to consider. More data for configuring approval phase instance rules is discussed with respect to the method of FIG. 5.

Additional rollout phases and approval phases and rules can be created at step 360. As a progressive rollout, the rollout is performed in multiple phases. For each actual rollout wave, there is a rollout phase and an approval phase. For example, a first rollout/approval phase may involve 25% of users, the second phase may include 50%, the third phase may include 75%, and fourth phase may include 100%. Once all the rollout phases and approval phases have been created, the pipeline can be saved at step 370.

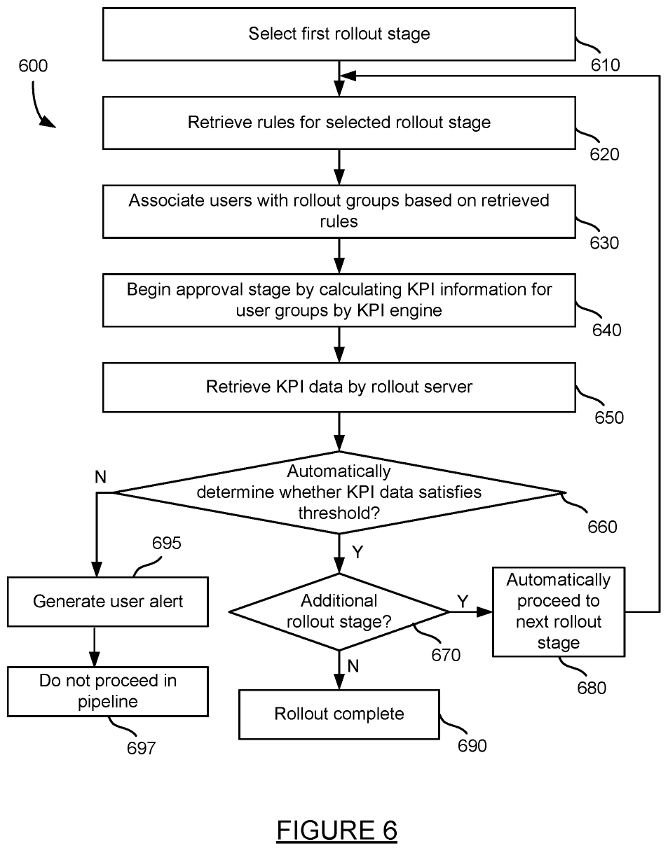

The rollout of the code change is then performed based on the generated pipeline and its phases at step 380. The rollout includes performing a rollout phase, executing an approval phase, and then performing additional rollout and approval phases if the approvals are made in the affirmative. More detail for performing rollout advocates code change based on pipeline is discussed with respect to the method of FIG. 6.

FIG. 4 is a method for configuring rollout phase rules. The method of FIG. 4 provides more detail for step 330 of the method of FIG. 3. The rollout phase rules including identifying what users of the software will be target users selected to receive a particular rollout. Each rollout phase in a pipeline may have the same or different rules sets, configured by the particular phase in the pipeline. The steps of FIG. 4 provide several ways of identifying target users, and any one or more the attributes and/or steps may be used to identify target users.

First, target users are identified at step 410. Target users may be identified based on email, a hash of their identifier, or other data. A geolocation of the target users may be set at step 420. In some instance, target users may be associate with a particular region, country, or other geographical location. An email or domain of the target users may be set at step 430. A beta user status may be set for the target users at step 440. In some instances, users currently active in a beta release may be selected to receive the update as a target user. Other attributes of target users may be set at step 450. Other attributes of desired target users may include a version of the software currently in use, and other attributes.

FIG. 5 is a method for configuring approval phase rules. The method of FIG. 5 provides more detail for step 350 of the method of FIG. 3. First, KPIs to be analyze are selected at step 510. Any of several KPIs may be analyzed, including CPU usage, response time, data base transaction growth, completed outcomes, and other KPIs. A desired KPI threshold level for approval is set at step 520. For example, an application may have a requirement to provide a certain performance level of that software tied to a particular KPI. For example, a response time KPI may be required to not be more than 0.04 milliseconds. In this case, the desired KPI level for response time would be 0.04 ms. KPI level thresholds may be generated for each KPI.

A service rollout success percentage threshold is set at step 530. The service rollout success percentage threshold may indicate whether the rollout has achieved or addressed the primary issue for which he was generated. For example, if there is a security breach in a previous version of a software application that the rollout is intended to address, the rollout must correct that breach in the code a certain threshold percentage of times, such as for example 98%. In this example, the rollout success percentage threshold would be set to 98%.

A preference for rollback upon failed approval is set at step 540. In case a particular rollout is not approved, one option is for the software to be rolled back to the previous version of the software. This may be set with a flag or other pipeline indicator by a user in the pipeline interface at step 540.

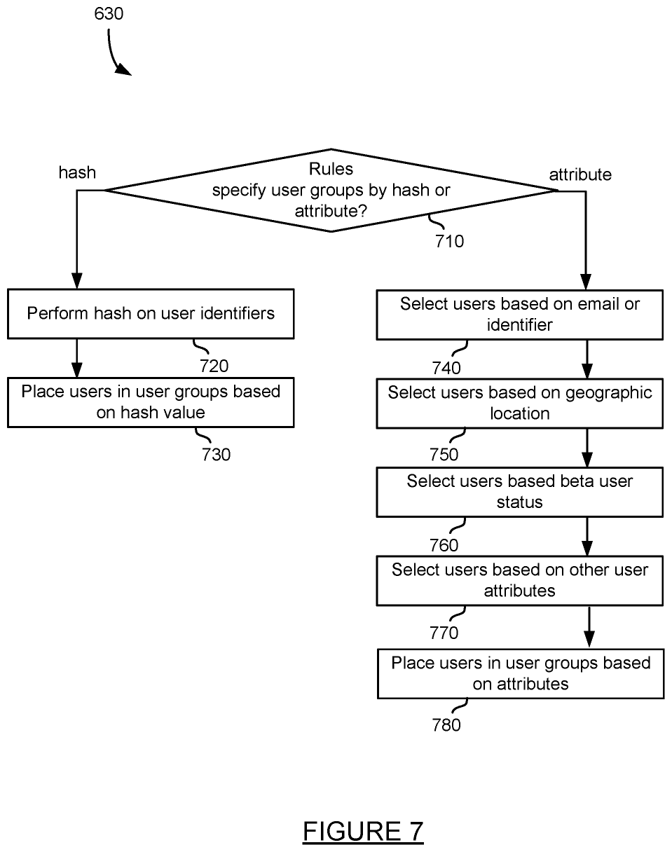

FIG. 6 is a method for performing a progressive rollout. The method of FIG. 6 provides more detail for step 380 of the method of FIG. 3. A first rollouts phase is selected at step 610. Rules are retrieved for the selected rollout phase at step 620. Users may be associated with rollout groups based on retrieved rules at step 630. Users may be associated with rollout groups based on their geographic location, user ID, and other attributes as set in the pipeline rollout phase. Associating users with a rollout group based on retrieved rules is discussed in more detail below with respect to the method of FIG. 7.

An approval phase is begun by calculating KPI information for user groups by a KPI engine at step 640. The KPI data to collect may include the KPI data configured for the original approval phase, which may include for example CPU usage, response time, database transaction growth, and other KPIs. The KPI data is retrieved by a rollout server at step 650. A determination is then made as to whether the KPI data satisfies a threshold at step 660. The determination is whether the KPI data satisfies its particular threshold is automatically determined by step 660, and no user reviewer analysis is required. If the KPI data does not satisfy the threshold, a user alert is generated at step 695 and the pipeline does not proceed at step 697. If the KPI data does satisfy a threshold, a determination is made as to whether there are additional rollout phases at step 670. If there are additional rollout phases, for example additional rollout phases having additional users, execution of the pipeline automatically proceeds to the next rollout phase step 680, and the method of FIG. 6 continues to step 620. There are no additional rollout phases, the rollout is complete at step 690.

FIG. 7 is a method for associating users with rollout groups based on a set of rules. The method of FIG. 7 provides more detail for step 630 of the method of FIG. 6. A determination is made as to whether the rules specify that user groups are to include target users by hash or by attribute at step 710. If user groups are to be generated from the target users by hash, a hash is performed on user identifiers at step 720. Users are then placed in an appropriate group based on the hash value at step 730. For example, if out of 100% of users, 25% are to be included in the first rollout phase, the lowest 25% of hash values can be included in the rollout group at step 730.

If user groups are to be filled with users based on attributes, then any of several attributes may be used to place users into the appropriate group. Steps 740-780 each specify a particular attribute, and all or less than all of the attributes discussed in step 740-780 may actually be used to select a target user for a group. Users may be selected for a group based on an email or identifier to be at step 740. Users may be selected based on geographic location at step 750. For example, a user may be selected for a particular group based on their country, whether they live in a metropolitan versus rural area, or some other geographic location attribute.

Users may be selected for a group based on their beta user status at step 760. For example, if a user is participating in a beta release of the software to be updated, it may be selected as part of a user target group. Users may be selected based on other attributes at step 770. Other attributes may include length of time associated with the application service, their shopping history, or some other attribute. Users are placed in the user groups based on attributes at step 780.

FIG. 8 is an interface for creating a rollout pipeline. Interface 800 of FIG. 8 includes a pipeline window a 10, and a phase window a 20. A pipeline is currently illustrated as having to phases in window a 10. A first step one rollout phase followed by an approval phase, followed by step two rollout phase, followed by a placeholder to add a phase is illustrated in window 810. The phase editor window a 20 illustrates information within the selected step two rollout phase. As separate phases are selected in window a 10, the details of each particular phase may be illustrated and edited in window a 20.

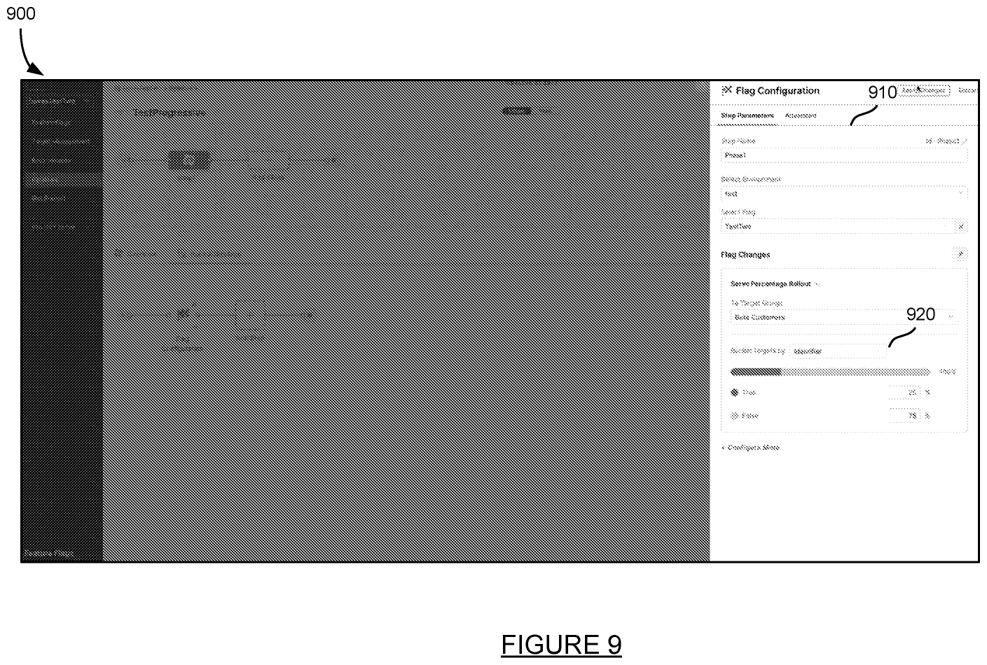

FIG. 9 is an interface for selecting rollout attributes. For a particular phase, several attributes may be configured by a user. For example, in first window 910 of interface 900, a user may configure a step name, an environment, and a flag for activating the rollout. Window 910 also includes boxes and inputs to specify a particular target group to include in the particular phase, as well as the percentage of target users that will receive the update, specified as true target users. The false are users are those that will not receive the update. In the interface 900 of FIG. 9, the true users make up 25% while the false users make up 75%.

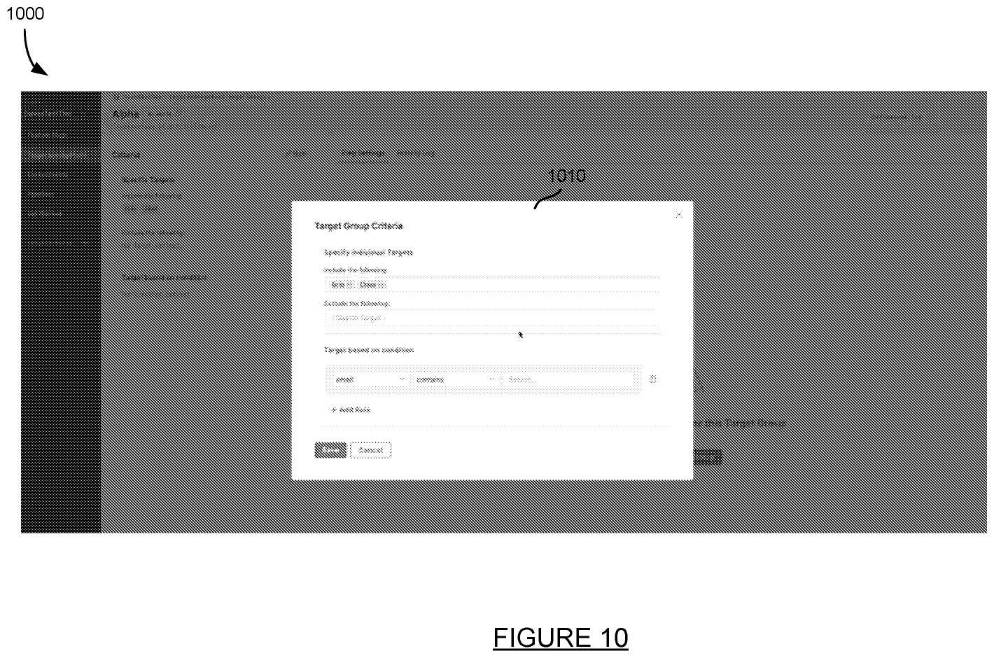

FIG. 10 is a method for adding users to a group. To add individual target users to a group, they may be added individually, or based on conditions. Individually, they can be added by indicating the name, user identifier, email, or some other identifying aspect of the user. To add them based on a condition, a user may specify that an email contains particular characters, a particular email domain, or some other aspect of them.

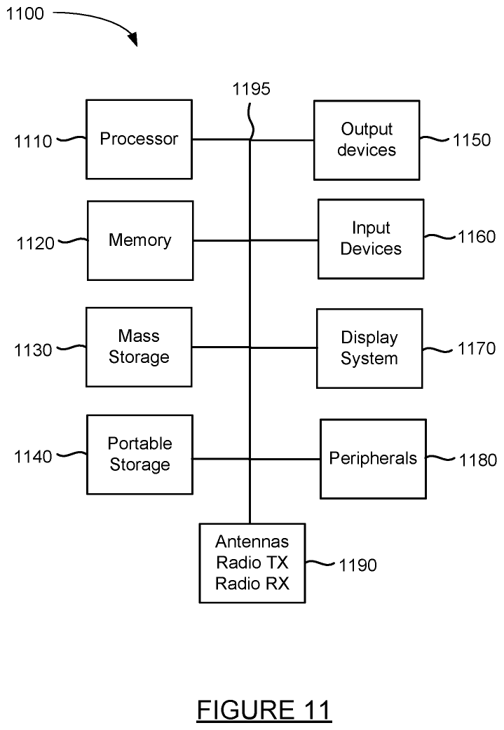

FIG. 11 is a block diagram of a computing environment for implementing the present technology. System 1100 of FIG. 11 may be implemented in the contexts of the likes of machines that implement client machines 110, SRM server 130, and application server 140. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically rolling out updates in phases, comprising:
configuring a plurality of rollout phases for an update to be applied to a plurality of remote machines, wherein each remote machine is associated with a user;
configuring a plurality of approval phases, each of the plurality of rollout phase associated with a rule set for determining if a software update is approved;
providing a software update to software associated with a first subset of the plurality of remote machines, the first subset associated with a first rollout and based on a first subset of the plurality of users associated with the subset of the plurality of machines;
automatically determining if the provided software update is approved based on the rule set, the rule set including one or more rules based on one or more key performance indicators for the software and one or more rules based on the performance of the software update; and
automatically providing the software update to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

2. The method of claim 1, wherein the first subset of the plurality of remote machines is selected based on being associated with the first subset of users, the first subset of user selected based on a hash of a user identifier associated with each user.

3. The method of claim 1, wherein the first subset of the plurality of remote machines is selected based on being associated with the first subset of users, the first subset of user selected based on at least one of a geographical location, user email domain, and a user beta release status.

4. The method of claim 1, wherein the first subset of users includes about 25% of the users using the software and the second subset of users includes about 50% of the users using the software.

5. The method of claim 1, wherein the key performance indicators include at least one of a central processing unit processing usage, growth of a particular transaction, and transaction response time.

6. The method of claim 1, wherein the performance of the software includes whether the software executes with a lower error frequency.

7. The method of claim 1, wherein configuring a plurality of rollout phases for an update and configuring a plurality of approval phases includes constructing a pipeline through a user interface, the pipeline including rollout phases and approval phases.

8. The method of claim 1, wherein comprising, falling back to a previous state of the software if an approval phase results in no approval.

9. A non-transitory computer readable storage medium having embodied thereon a program, the program being executable by a processor to perform a method for automatically rolling out updates in phases, the method comprising:
configuring a plurality of rollout phases for an update to be applied to a plurality of remote machines, wherein each remote machine is associated with a user;
configuring a plurality of approval phases, each of the plurality of rollout phase associated with a rule set for determining if a software update is approved;
providing a software update to software associated with a first subset of the plurality of remote machines, the first subset associated with a first rollout and based on a first subset of the plurality of users associated with the subset of the plurality of machines;
automatically determining if the provided software update is approved based on the rule set, the rule set including one or more rules based on one or more key performance indicators for the software and one or more rules based on the performance of the software update; and
automatically providing the software update to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

10. The non-transitory computer readable storage medium of claim 9, wherein the first subset of the plurality of remote machines is selected based on being associated with the first subset of users, the first subset of user selected based on a hash of a user identifier associated with each user.

11. The non-transitory computer readable storage medium of claim 9, wherein the first subset of the plurality of remote machines is selected based on being associated with the first subset of users, the first subset of user selected based on at least one of a geographical location, user email domain, and a user beta release status.

12. The non-transitory computer readable storage medium of claim 9, wherein the first subset of users includes about 25% of the users using the software and the second subset of users includes about 50% of the users using the software.

13. The non-transitory computer readable storage medium of claim 9, wherein the key performance indicators include at least one of a central processing unit processing usage, growth of a particular transaction, and transaction response time.

14. The non-transitory computer readable storage medium of claim 9, wherein the performance of the software includes whether the software executes with a lower error frequency.

15. The non-transitory computer readable storage medium of claim 9, wherein configuring a plurality of rollout phases for an update and configuring a plurality of approval phases includes constructing a pipeline through a user interface, the pipeline including rollout phases and approval phases.

16. The non-transitory computer readable storage medium of claim 9, wherein comprising, falling back to a previous state of the software if an approval phase results in no approval.

17. A system for automatically rolling out updates in phases, comprising:
a server including a memory and a processor; and
one or more modules stored in the memory and executed by the processor to configure a plurality of rollout phases for an update to be applied to a plurality of remote machines, wherein each remote machine is associated with a user, configure a plurality of approval phases, each of the plurality of rollout phase associated with a rule set for determining if a software update is approved, provide a software update to software associated with a first subset of the plurality of remote machines, the first subset associated with a first rollout and based on a first subset of the plurality of users associated with the subset of the plurality of machines, automatically determine if the provided software update is approved based on the rule set, the rule set including one or more rules based on one or more key performance indicators for the software and one or more rules based on the performance of the software update, and automatically provide the software update to software associated with a second subset of the plurality of remote machines, the software update automatically provided to the second subset of the plurality of machines based on a determination that the software provided to the first subset was approved, the second subset associated with a second rollout and based on a second subset of the plurality of users that is greater than the number of users associated with the first rollout.

18. The system of claim 1, wherein the first subset of the plurality of remote machines is selected based on being associated with the first subset of users, the first subset of user selected based on a hash of a user identifier associated with each user.

19. The system of claim 1, wherein the first subset of the plurality of remote machines is selected based on being associated with the first subset of users, the first subset of user selected based on at least one of a geographical location, user email domain, and a user beta release status.

20. The system of claim 1, wherein the first subset of users includes about 25% of the users using the software and the second subset of users includes about 50% of the users using the software.
